(19) United States
(12) Patent Application Publication
(10) Pub. No.: US 2013/0020529 A1
(43) Pub. Date: Jan. 24, 2013

(54) METHOD FOR MANUFACTURING MAGNETO CALORIC DEVICE

(71) Applicants: Li CHANG, TAOYUAN HSIEN (TW); Shih-Pin MENG, TAOYUAN HSIEN (TW); Mao-Jen HSU, TAOYUAN HSIEN (TW); Chung-Jung KUO, TAOYUAN HSIEN (TW)

(72) Inventors: Li CHANG, TAOYUAN HSIEN (TW); Shih-Pin MENG, TAOYUAN HSIEN (TW); Mao-Jen HSU, TAOYUAN HSIEN (TW); Chung-Jung KUO, TAOYUAN HSIEN (TW)

(73) Assignee: DELTA ELECTRONICS, INC., TAOYUAN HSIEN (TW)

(21) Appl. No.: 13/553,824

(22) Filed: Jul. 20, 2012

Related U.S. Application Data
(60) Provisional application No. 61/510,489, filed on Jul. 22, 2011.

(51) Int. Cl. C09K 3/00; B05D 7/00

(52) U.S. Cl. 252/70; 427/128; 427/130

(57) ABSTRACT

Disclosed herein is a method for manufacturing a magneto caloric device. Magneto caloric powders are mixed with thermally conductive powders to form a composite material. An adhesive containing an acrylic resin is poured on the composite material and diffused among the composite material. The adhesive is cured within the composite material at a room temperature.

### RELATED APPLICATIONS

This application claims priority to U.S. Provisional Application Ser. No. 61/510,489, filed Jul. 22, 2011, which is herein incorporated by reference.

### BACKGROUND

1. Field of Invention

The present invention relates to a method for manufacturing a magneto caloric device.

2. Description of Related Art

A magneto caloric device has been used within a magnetic field to perform a heat transferring function for cooling or heating a desired target. In a practical embodiment, an attempt is made to transfer heat by means of working liquids flowing in heat contact with the magneto caloric device, which is basically made of magneto caloric powders bound by an adhesive. After long hours of experiment, the magneto caloric device is found to be peeled by the working liquids. In particular, the magneto caloric powders are gradually removed from the magneto caloric device by the working liquids, which may result in a less effective heat transferring function. For the forgoing reasons, there is a need for improving the magneto caloric device, which is basically made of magneto caloric powders bound by an adhesive.

### SUMMARY

In an aspect of the present invention, a method for manufacturing a magneto caloric device includes the following steps. Magneto caloric powders are mixed with thermally conductive powders to form a composite material. An adhesive containing an acrylic resin is poured on the composite material and diffused among the composite material. The adhesive is cured within the composite material at a room temperature.

According to an embodiment disclosed herein, the thermally conductive powders include cooper, aluminum or sliver.

According to another embodiment disclosed herein, the magneto caloric powders have an average diameter d₁ while the thermally conductive powders have an average diameter d₂, and the ratio of d₁/d₂ ranges from about 1/5 to about 1/10.

According to another embodiment disclosed herein, the magneto caloric powders have an average diameter d₁ while the thermally conductive powders have an average diameter d₂, and the ratio of d₁/d₂ ranges from about 5 to about 10.

According to another embodiment disclosed herein, the adhesive is diffused among the composite material without stirring the magneto caloric powders and thermally conductive powders.

In an aspect of the present invention, a method for manufacturing a magneto caloric structure includes the following steps. An adhesive layer is formed and a plurality of magneto caloric material chips are spread on the adhesive layer.

According to an embodiment disclosed herein, the adhesive layer is formed to have a thickness less than an average diameter of the magneto caloric material chips.

According to another embodiment disclosed herein, the adhesive layer is formed to have a thickness equal to an average radius of the magneto caloric material chips.

According to another embodiment disclosed herein, the method further includes the step of embedding each magneto caloric material chip partially within the adhesive layer after spreading the magneto caloric material chips on the adhesive layer.

According to another embodiment disclosed herein, the method further includes the step of curing the adhesive layer at a room temperature after embedding each magneto caloric material chip partially within the adhesive layer.

According to another embodiment disclosed herein, the method further includes the step of embedding each magneto caloric material chip partially within the adhesive layer before the adhesive layer is completely cured.

According to another embodiment disclosed herein, the adhesive layer comprises acrylic resin.

According to another embodiment disclosed herein, the magneto caloric material chips have an average radius ranging from about 50 μm to about 5 mm.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a cross-sectional view of a composite material consisting of magneto caloric powders and thermally conductive powders according to one embodiment of this invention;

FIG. 2 illustrates an enlarged cross-sectional view of a microstructure magnified by a magnifier within the composite material as illustrated in FIG. 1;

FIG. 3 illustrates a flowchart of a method for manufacturing a magneto caloric device according to another embodiment of this invention; and

FIG. 4 illustrates a cross-sectional view of a magneto caloric device according to still another embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

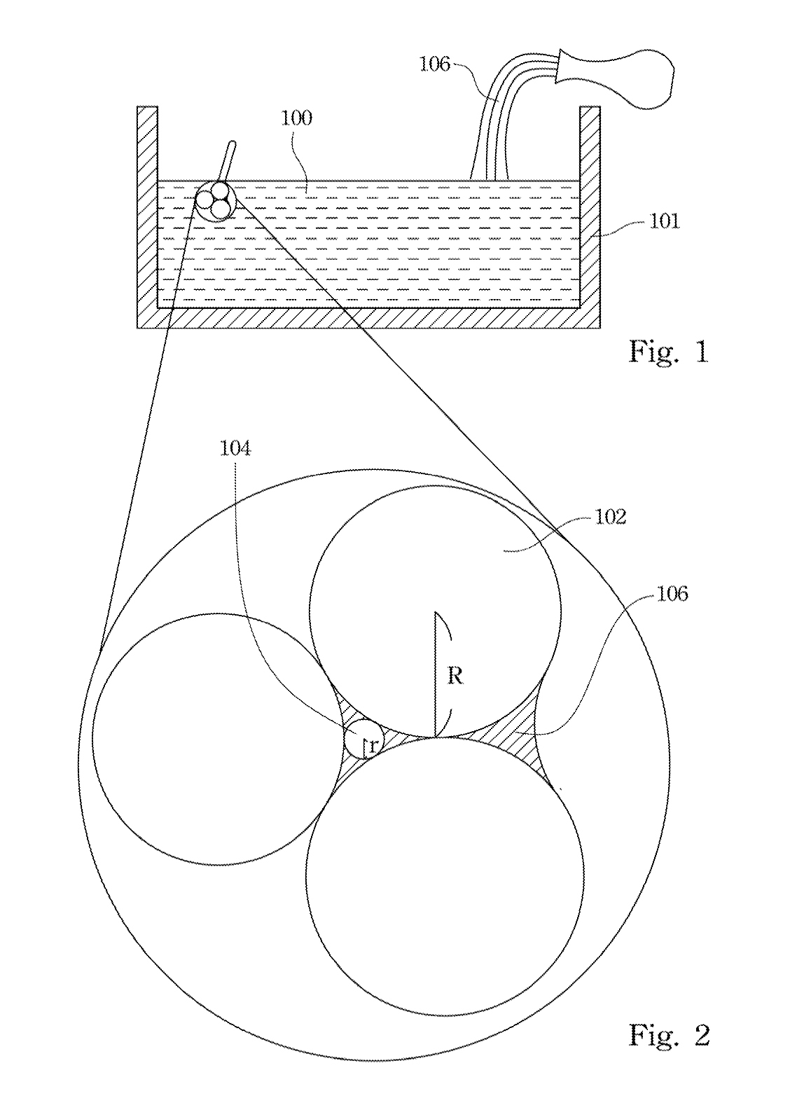

FIG. 1 illustrates a cross-sectional view of a composite material including mixed magneto caloric powders and thermally conductive powders according to one embodiment of this invention. A mold 101 is used to give a desired shape to the composite material 100, which contains mixed magneto caloric powders and thermally conductive powders. An adhesive 106 is poured on the composite material 100 and let it diffused naturally (partially caused by gravity) to fill the tiny gaps among mixed magneto caloric powders and thermally conductive powders.

Thermally conductive powders can be cooper, aluminum or sliver powers, etc. Thermally conductive powders are to enhance the thermal conductivity of the composite material 100. In an embodiment, the composite material 100, which contains cooper powers, has the thermal conductivity up to 400.5 W/mK. In another embodiment, the composite material, which is bound by the adhesive (e.g. acrylic resin) and does not contain extra thermally conductive powders, has the thermal conductivity up to 0.23 W/mK.

Acrylic resin is chosen to be the adhesive for binding the mixed magneto caloric powders and thermally conductive powders because (1) acrylic resin results in few bubbles within the composite material 100, and (2) no extra heat is needed, e.g. at a room temperature, to cure the composite material 100 when acrylic resin diffuses to fill the tiny gaps among mixed magneto caloric powders and thermally conductive powders. When extra heat is used to cure the composite material 100, more bubbles may be generated within the composite material 100, thereby degrading the thermal conductivity of the composite material 100.

Epoxy is also used as the adhesive for binding the mixed magneto caloric powders and thermally conductive powders to serve a comparison to acrylic resin. Extra heat is needed to cure the composite material 100 when epoxy diffuses to fill the tiny gaps among mixed magneto caloric powders and thermally conductive powders. More bubbles are generated within the composite material 100 compared with the composite material 100 containing acrylic resin as the adhesive.

FIG. 2 illustrates an enlarged cross-sectional view of a microstructure (magnified by a magnifier) within the composite material as illustrated in FIG. 1. In an embodiment, a relatively big particle 102 (which has a radius R) is the magneto caloric powder while a relatively small particle 104 (which has a radius r) is the thermally conductive powder. In order to obtain smaller gaps among mixed magneto caloric powders and thermally conductive powders, an average diameter d₁ of the magneto caloric powders (e.g. 2R) and an average diameter d₂ of the thermally conductive powders (e.g. 2r) should be controlled within a ratio range. In this embodiment, the ratio of d₁/d₂ ranges from about 5 to about 10. In an alternate embodiment, a relatively big particle 102 (which has a radius R) is the thermally conductive powder while a relatively small particle 104 (which has a radius r) is the magneto caloric powder. In order to obtain smaller gaps among mixed magneto caloric powders and thermally conductive powders, an average diameter d₁ of the magneto caloric powders (e.g. 2r) and an average diameter d₂ of the thermally conductive powders (e.g. 2R) should be controlled within a ratio range. In this embodiment, the ratio of d₁/d₂ ranges from about 1/5 to about 1/10.

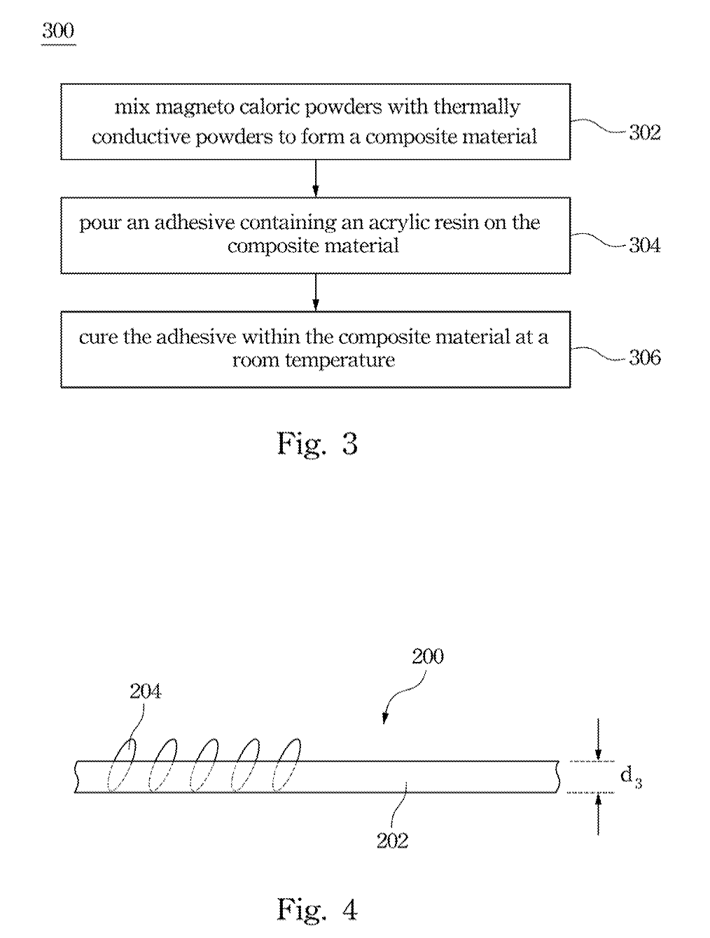

FIG. 3 illustrates a flowchart of a method 300 for manufacturing a magneto caloric device according to another embodiment of this invention. This method 300 for manufacturing a magneto caloric device at least includes the following three steps.

In step 302, magneto caloric powders are well and uniformly mixed with thermally conductive powders to form a composite material. This step can be performed manually or by a machine.

In step 304, an adhesive containing an acrylic resin is poured evenly on the composite material after magneto caloric powders and thermally conductive powders are well mixed. It is preferred that the acrylic resin adhesive can be diffused among the composite material without stirring the magneto caloric powders and thermally conductive powders, e.g. let the acrylic resin adhesive naturally (partially caused by gravity) to fill the tiny gaps among mixed magneto caloric powders and thermally conductive powders, so as to decrease bubbles within the composite material as few as possible.

In step 306, the composite material is put in a room temperature environment to cure the acrylic resin adhesive, e.g. no extra heat is added.

FIG. 4 illustrates a cross-sectional view of a magneto caloric device according to still another embodiment of this invention. In this embodiment, a magneto caloric device is introduced with a simpler stricture (compared with the magneto caloric device as illustrated in FIG. 1). This magneto caloric device 200 is formed by at least the following two steps. An adhesive layer 202 (e.g. an acrylic resin adhesive) is formed and then a plurality of magneto caloric material chips 204 are spread and bound on the adhesive layer 202. In this embodiment, the magneto caloric material chips 204 have a bigger average radius (e.g. about 50 μm˜5 mm) than the above-mentioned magneto caloric powders. In an embodiment, the adhesive layer 202 is formed to have a thickness d₃ less than an average diameter of the magneto caloric material chip 204. In another embodiment, the adhesive layer 202 is formed to have a thickness d₃ equal to an average diameter of the magneto caloric material chip 204. In another embodiment, each magneto caloric material chip 204 is embedded partially within the adhesive layer (manually or by a machine) after spreading the magneto caloric material chips 204 on the adhesive layer 202. In another embodiment, the adhesive layer 202 is cured at a room temperature after embedding each magneto caloric material chip 204 partially within the adhesive layer 202. In still another embodiment, each magneto caloric material chip 204 is embedded partially within the adhesive layer before the adhesive layer 202 is completely cured.

The magneto-caloric material may be FeRh, Gd₅Si₂Ge₂, Gd₅(Si₁₋ₓGeₓ)₄, RCo₂, La(Fe₁₃₋ₓSiₓ), MnAs₁₋ₓSbₓ, MnFe(P, As), Co(S₁ₓSeₓ)₂, NiMnSn, MnCoGeB or R₁₋ₓMₓMnO₃, (where R=lanthanide, M=Ca, Sr and Ba), . . . etc.

According to the discussed embodiments, an improved method for manufacturing a reliable magneto caloric device is provided to prevent the magneto caloric device from being removed by a flowing liquid, thereby maintaining an effective heat transferring function of the magneto caloric device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for manufacturing a magneto caloric device comprising:
mixing magneto caloric powders with thermally conductive powders to form a composite material;
pouring an adhesive containing an acrylic resin on the composite material and diffusing the adhesive among the composite material; and
curing the adhesive within the composite material at a room temperature.

2. The method of claim 1, wherein the thermally conductive powders comprise cooper, aluminum or sliver.

3. The method of claim 1, wherein the magneto caloric powders have an average diameter d₁ while the thermally conductive powders have an average diameter d₂, and the ratio of d₁/d₂ ranges from about 1/5 to about 1/10.

4. The method of claim 1, wherein the magneto caloric powders have an average diameter d₁ while the thermally conductive powders have an average diameter d₂, and the ratio of d₁/d₂ ranges from about 5 to about 10.

5. The method of claim 1, wherein the adhesive is diffused among the composite material without stirring the magneto caloric powders and thermally conductive powders.

6. A method for manufacturing a magneto caloric device comprising:
forming an adhesive layer; and
spreading a plurality of magneto caloric material chips on the adhesive layer.

7. The method of claim 6, wherein the adhesive layer is formed to have a thickness less than an average diameter of the magneto caloric material chips.

8. The method of claim 6, where the adhesive layer is formed to have a thickness equal to an average radius of the magneto caloric material chips.

9. The method of claim 6, further comprising:
embedding each magneto caloric material chip partially within the adhesive layer after spreading the magneto caloric material chips on the adhesive layer.

10. The method of claim 9, further comprising:
curing the adhesive layer at a room temperature after embedding each magneto caloric material chip partially within the adhesive layer.

11. The method of claim 9, further comprising:
embedding each magneto caloric material chip partially within the adhesive layer before the adhesive layer is completely cured.

12. The method of claim 6, wherein the adhesive layer comprises acrylic resin.

13. The method of claim 6, wherein the magneto caloric material chips have an average radius ranging from about 50 μm to about 5 mm.
